(19) United States
(12) Patent Application Publication
(10) Pub. No.: US 2013/0249286 A1
(43) Pub. Date: Sep. 26, 2013

(54) POWER SUPPLY DEVICE FOR SERVER CABINETS

(71) Applicants: KUEI-CHIH HOU, Tu-Cheng (TW); TENG-YUAN SHU, Tu-Cheng (TW)

(72) Inventors: KUEI-CHIH HOU, Tu-Cheng (TW); TENG-YUAN SHU, Tu-Cheng (TW)

(73) Assignee: HON HAI PRECISION INDUSTRY CO., LTD., Tu-Cheng (TW)

(21) Appl. No.: 13/585,756

(22) Filed: Aug. 14, 2012

(30) Foreign Application Priority Data
Mar. 21, 2012 (TW) 101109765

(51) Int. Cl. H02J 3/00

(52) U.S. Cl. 307/18

(57) ABSTRACT

A power supply device includes a power distribution unit (PDU) and a plurality of power supply units (PSUs). The PSUs are all electrically connected to the PDU and structurally integrated therewith. The PDU receives an external three-phase alternating current (AC) voltage and transforms the three-phase AC voltage into three types of single-phase AC voltages having different phases. Each of the PSUs receives one of the three types of single-phase AC voltages, regulates the received single-phase AC voltage, and outputs the regulated single-phase AC voltage for supplying electric power.

### BACKGROUND

1. Technical Field

The present disclosure relates to power supply devices, and particularly to a power supply device for server cabinets.

2. Description of Related Art

A server cabinet may contain a plurality of servers and require a special power supply device for simultaneously supplying electrical power to these servers. A power supply device for server cabinets may include a power distribution unit (PDU) and a plurality of power supply units (PSUs). The PSUs are all electrically connected to the PDU. In use, the power supply device is installed in a server cabinet that receives a plurality of servers, and the PSUs are respectively electrically connected to the servers. The PDU receives electrical power from an external power supply (e.g., a wall socket or a battery). Each of the PSUs receives electrical power from the PDU, regulates the received electrical power (e.g., in respect of voltage value, current value, and alternating frequency), and transmits the regulated electrical power to the server corresponding to the PSU.

In an above-described power supply device, the PDU and all of the PSUs are generally independent devices. Thus, the PDU and all of the PSUs may occupy much space in the server cabinet and together generate excessive heat.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a block diagram of a power supply device, according to an exemplary embodiment.

FIG. 2 is a block diagram of the power supply device shown in FIG. 1 supplying electrical power to a plurality of servers contained in a server cabinet.

### DETAILED DESCRIPTION

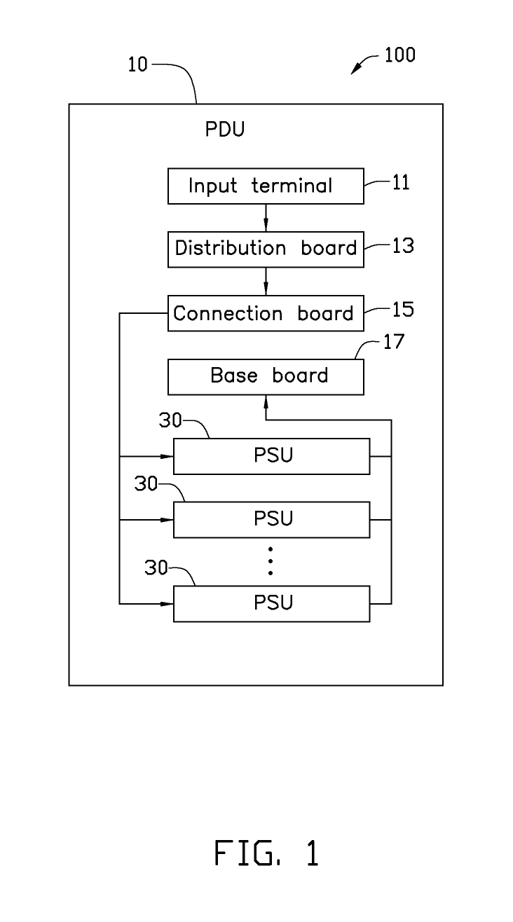

FIG. 1 is a block diagram of a power supply device 100, according to an exemplary embodiment. The power supply device 100 can be positioned in a server cabinet to simultaneously supply electrical power to a plurality of servers received in the server cabinet. The power supply device 100 includes a power distribution unit (PDU) 10 and a plurality of power supply units (PSUs) 30 corresponding to the plurality of servers. The PSUs 30 are all electrically connected to the PDU 10 and structurally integrated with the PDU 10. The PDU 10 can be electrically connected to an external three-phase alternating current (AC) power supply to receive a three-phase AC voltage, and can transform the three-phase AC voltage into three types of single-phase AC voltages having different phases. Each of the PSUs 30 receives one of the three types of single-phase AC voltages from the PDU 10, regulates the received single-phase AC voltages (e.g., in respect of peak value, effective value, and alternating frequency), and transmit the regulated single-phase AC voltage to the server corresponding to the PSU 30.

The PDU 10 includes an input terminal 11, a distribution board 13, a connection board 15, and a base board 17. The input terminal 11, the distribution board 13, and the connection board 15 are electrically connected in series. The PSUs 30 are all electrically connected in parallel between the connection board 15 and the base board 17, and each of the PSUs 30 can be electrically connected to a corresponding server via the base board 17. Furthermore, the PSUs 30 are all structurally held between the connection board 15 and the base board 17, that is, structurally integrated with the PDU 10.

The input terminal 11 is a circuit breaker. The input terminal 11 is configured to be electrically connected to the external three-phase AC power supply to receive the three-phase AC voltage. The distribution board 13 is configured to conduct portions of the three-phase AC voltage having different phases to different circuits, respectively, and thereby transform the three-phase AC voltage into the three types of single-phase AC voltages having different phases.

The connection board 15 includes a plurality of sockets 151. The sockets 151 are all electrically connected to the distribution board 13, and the PSUs 30 are respectively electrically connected to the sockets 151. The PSUs 30 are all electrically connected to the base board 17. Each of the sockets 151 can receive one of the three types of single-phase AC voltage from the distribution board 13, and transmits the received single-phase AC voltage to the PSU 30 electrically connected to the socket 151. Thus, the PSU 30 electrically connected to the socket 151 can supply electrical power to a corresponding server via the base board 17.

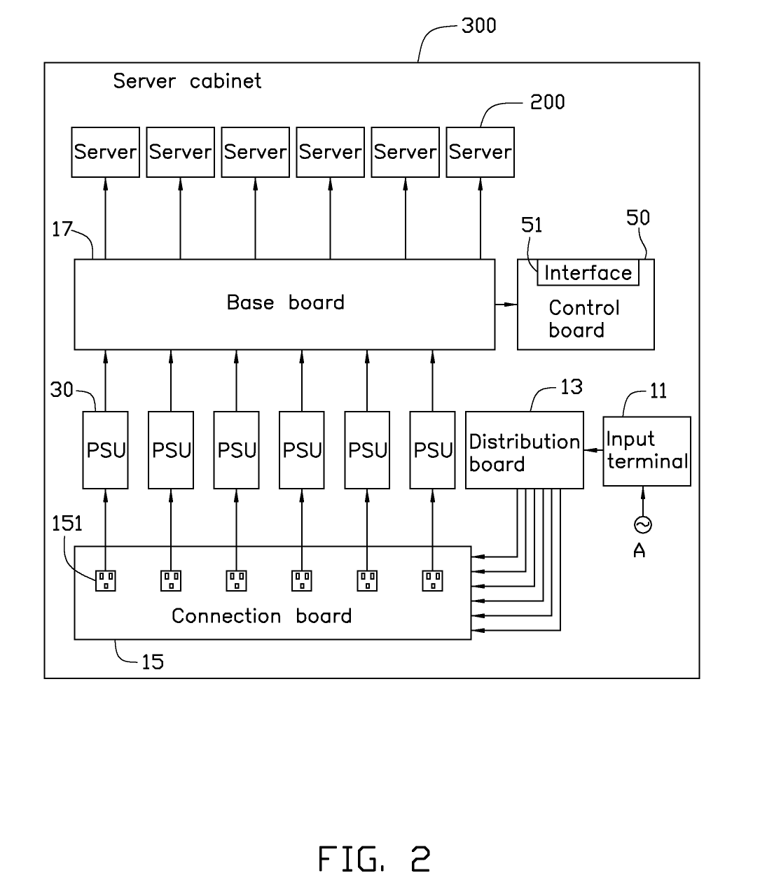

Also referring to FIG. 2, the power supply device 100 is used to supply electrical power to a plurality of servers 200. The power supply device 100 and the servers 200 are all received in a server cabinet 300, and the servers 200 are respectively electrically connected to the PSUs 30 via the base board 17. The server cabinet 300 includes a three-phase AC power supply A.

In use, the input terminal 11 is electrically connected to the three-phase AC power supply A and receive a three-phase AC voltage. The distribution board 13 transforms the three-phase AC voltage into three types of single-phase AC voltages having different phases. Each of the sockets 151 receives one of the three types of single-phase AC voltages from the distribution board 13, and transmits the received single-phase AC voltage to the PSU 30 electrically connected to the socket 151. Each of the PSUs 30 receives one of the three types of single-phase AC voltages from the socket 151 corresponding to the PSU 30, regulates the received single-phase AC voltage (e.g., in respect of peak value, effective value, and alternating frequency), and transmits the regulated single-phase AC voltage to the server 200 electrically connected to the PSU 30. In this way, the power supply device 200 can supply all the electrical power required by the individual servers 200 at the same time.

In this embodiment, the power supply device 100 includes six PSUs 30, and the connection board 15 includes six sockets 151. Each type of the single-phase AC voltages generated by the distribution board 13 is transmitted to two of the PSUs 30 via two of the sockets 151, respectively. That is, every two of the PSUs 30 share one of the three types of the single-phase AC voltages.

In other embodiments, the total number of the PSUs 30 is variable, and the number of the PSUs 30 sharing one particular type of the three types of single-phase AC voltage can also be changed. The number of the PSUs 30 required is irrelevant, and there is no upper limit to this number. The PSUs 30 are all structurally received held between the connection board 15 and the base board 17, that is, structurally integrated with the PDU 10. Thus, space inside the server cabinet 300 is conserved, and the PSUs 30 in this arrangement generate much less heat than PSUs in an independent arrangement.

The power supply device 100 can further include a control board 50. The control board 50 is electrically connected to the base board 17 and includes an interface configured to be electrically connected to an external data processing unit (not shown), such as a personal computer (PC). When the power supply device 100 is used, via the control board 50, the external data processing unit can detect and monitor relative parameters (e.g., voltage values, current values, and alternating frequencies) of each of the PSUs 30.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A power supply device, comprising:
a power distribution unit (PDU) configured to receive an external three-phase alternating current (AC) voltage and transform the three-phase AC voltage into three types of single-phase AC voltages having different phases; and
a plurality of power supply units (PSUs) electrically connected to the PDU and structurally integrated with the PDU;
wherein each of the PSUs receives one of the three types of single-phase AC voltages, regulates the received single-phase AC voltage, and outputs the regulated single-phase AC voltage for supplying electric power.

2. The power supply device of claim 1, wherein the PDU includes a distribution board, the distribution board configured to conduct portions of the three-phase AC voltage having different phases to different circuits, respectively, and cause the three-phase AC voltage to be transformed into the three types of single-phase AC voltages having different phases.

3. The power supply device of claim 2, wherein the PDU further includes a connection board electrically connected to the distribution board, the connection board includes a plurality of sockets, the PSUs are respectively electrically connected to the sockets, and each of the PSUs receives one of the three types of single-phase AC voltages from the socket electrically connected with the PSU and regulates the received single-phase AC voltage.

4. The power supply device of claim 3, wherein the PDU further includes a base board, the PSUs are all electrically connected to the base board, and the single-phase AC voltages regulated by the PSUs are all output from the base board.

5. The power supply device of claim 4, wherein the PSUs are all structurally held between the connection board and the base board.

6. The power supply device of claim 4, wherein the PDU further includes a control board electrically connected to the base board and configured to detect relative parameters of electrical power provided by the PSUs.

7. A power supply device, comprising:
a power distribution unit (PDU), the PDU including:
an input terminal configured to receive an external voltage;
a distribution board electrically connected to the input terminal;
a connection board electrically connected to the distribution board; and
a base board configured to output electrical power; and
a plurality of power supply units (PSUs) electrically connected in parallel between the connection board and the base board and structurally held between the connection board and the base board;
wherein the external voltage is regulated by the distribution board and the plurality of PSUs, and then is output from the base board to supply electrical power.

8. The power supply device of claim 7, wherein the input terminal is configured to receive a three-phase alternating current (AC) voltage, and the distribution board is configured to conduct portions of the three-phase AC voltage having different phases to different circuits, respectively, and cause the three-phase AC voltage to be transformed into the three types of single-phase AC voltages having different phases.

9. The power supply device of claim 8, wherein the connection board includes a plurality of sockets, the PSUs are respectively electrically connected to the sockets, and each of the PSUs receives one of the three types of single-phase AC voltages from the socket electrically connected with the PSU and regulates the received single-phase AC voltage.

10. The power supply device of claim 9, wherein the single-phase AC voltages regulated by the PSUs are all output from the base board.

11. The power supply device of claim 7, wherein the input terminal is a circuit breaker.

12. The power supply device of claim 7, wherein the PDU further includes a control board electrically connected to the base board and configured to detect relative parameters of electrical power provided by the PSUs.
